(19) United States
(12) Patent Application Publication
(10) Pub. No.: US 2007/0006296 A1
(43) Pub. Date: Jan. 4, 2007

(54) System and method for establishing a shared key between network peers

(76) Inventors: Madjid F. Nakhjiri, Palatine, IL (US); Vidya Narayanan, Schaumburg, IL (US); Narayanan Venkitaraman, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/169,406

(22) Filed: Jun. 29, 2005

(51) Int. Cl. G06F 15/16

(52) U.S. Cl. 726/15

(57) ABSTRACT

An Authentication, Authorization, and Accounting (AAA) key, defining a first shared secret between a mobile node (108) and an AAA server (110), is acquired. A shared key becomes associated with the mobile node (108) and the VPN server (104). The shared key is formed, at least in part, from the AAA key. The shared key defines a second shared secret, which is between the mobile node (108) and the VPN server (104). A secure data tunnel is then established between the mobile node (108) and the VPN server (104) using the shared key.

### FIELD OF THE INVENTION

The field of the invention relates to routing communications through networks and, more specifically, to establishing a secure data path through these networks between different network entities.

### BACKGROUND OF THE INVENTION

The Mobile Internet Protocol (MIP) is a protocol that assists in routing messages between mobile nodes as these mobile nodes move within and between networks. As messages are exchanged, current systems typically attempt to route the messages in a secure manner. Specifically, MIP requires that most MIP messages be first authenticated in order to be processed. In order to be accomplished properly, MIP authentication requires that a shared key exist between different entities such as between a home agent and its associated mobile nodes.

Private networks that need to restrict access to users can use Virtual Private Network (VPN) gateways. Some of these gateways employ the IP Security Protocol (IPsec) for providing data encryption services and are known as IPsec VPN gateways. The keys, algorithms, and other parameters (collectively referred to as Security Associations (SAs)), used to provide IPSec must be first negotiated in a secure manner. Typically, an Internet key exchange (IKE) is used for performing this negotiation. More specifically, the negotiation requires that the two peers at each end of a communication channel prove their claimed identity to each other (i.e., authenticate each other) by having each peer sign their identity using a cryptographic key.

In many systems, a symmetric shared key is a common type of cryptographic key used for some IKE authentication. In some previous systems, the shared keys used for mutual authentication were established by manually configuring each of the peers with the keys. Unfortunately, this approach can only be implemented by incurring a large administrative overhead and at a substantial cost. Other previous systems used public key certificates to perform the authentication required by the IKE. However, these certificates must be issued and managed by a public key infrastructure (PKI) certificate authority (CA). As with the manual configuration approach, using certificates proved complex and costly to implement and resulted in a significant amount of additional system overhead.

### BRIEF DESCRIPTION OF THE DRAWINGS

FIG. 1 is a block diagram of a system for establishing a shared key between peers according to the present invention;

FIG. 2 is a call-flow diagram of an approach to provide a shared key between network peers according to the present invention;

FIG. 3 is a call-flow diagram of another approach to provide a shared key between network peers according to the present invention;

FIG. 4 is a block diagram of a mobile-Virtual Private Network (VPN) server authentication extension according to the present invention;

FIG. 5 is a block diagram of a generalized mobile node-to-home agent key generation nonce reply extension according to the present invention;

FIG. 6 is a block diagram of a mobile node-to-home agent key generation nonce from the AAA data subtype according to the present invention;

FIG. 7 is a block diagram of a mobile node-to-VPN server key generation nonce request extension according to the present invention;

FIG. 8 is a block diagram of a generalized mobile node-to-VPN key generation nonce reply extension according to the present invention;

FIG. 9 is a block diagram of the field 808 of the mobile node-VPN key generation nonce from AAA extension of FIG. 8 according to the present invention;

FIG. 10 is a block diagram of a generalized RADIUS attribute according to the present invention; and

FIG. 11 is a block diagram of an Authentication, Authorization, and Accounting (AAA) server according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method facilitates the creation of a secure data tunnel between two peers, such as a mobile node and a Virtual Private Network (VPN) server, using a shared key. At the same time keys are created for MIP signaling, keys for the establishment of a VPN IPsec channel are also created and distributed. The approaches described herein are simple and cost effective to implement, result in the ability of network entities to conduct secure communications in a network or between networks, and do not create additional burdensome system overhead.

In many of these embodiments, an Authentication, Authorization, and Accounting (AAA) key, defining a first shared secret between a mobile node and an AAA server, is acquired. A shared key is formed and becomes associated with the mobile node and the VPN server. The shared key is formed, at least in part, from the AAA key, and defines a second shared secret, which is between the mobile node and the VPN server. A secure data tunnel can then be established between the mobile node and the VPN server using the shared key.

In some of these embodiments, the shared key may become associated with the mobile node and the VPN server by creating a nonce representing the shared key at the AAA server. Then, the nonce is sent to the mobile node and the shared key is responsively formed at the mobile node using the nonce. In addition, the shared key may be formed at the AAA server and sent the VPN server. Thus, a shared key is established at both the mobile node and the VPN server.

In many of these embodiments, the nonce is sent to the mobile node via the VPN server and the home agent. The nonce may be sent over an unprotected connection to the mobile node and the shared key may be sent to the VPN server over a protected connection.

A registration request, including a user-defined key generation extension, may be sent from the mobile node to the AAA server to initiate the forming of the shared key. This request may be a Remote Authentication Dial-In User Service (RADIUS) request or a Diameter request. The registration request may also be authenticated at the AAA server.

In still others of these embodiments, a shared key is formed between a mobile node and a VPN server. A first key that defines a first shared secret is established between a mobile node and a first server using a signaling mechanism. A set of shared keys is established and a set of cryptographic parameters is negotiated using the first key and the signaling mechanism. The set of shared keys defines a set of second shared secrets that are shared between the mobile node and the VPN server.

Various options may be used to physically position the home agent and the VPN server. For instance, in one approach, the home agent and VPN server may be collocated within a single housing unit. Alternatively, in another approach, the two units may be housed in separate units.

Thus, approaches are described that establish secure data tunnels between network peers that reduce network overhead, are cost effective to implement, and do not require extensive user interaction or programming. More specifically, as compared to previous systems, the approaches described herein do not require the custom configuration of keys at individual nodes or the provisioning and processing of certificates from a certificate authority.

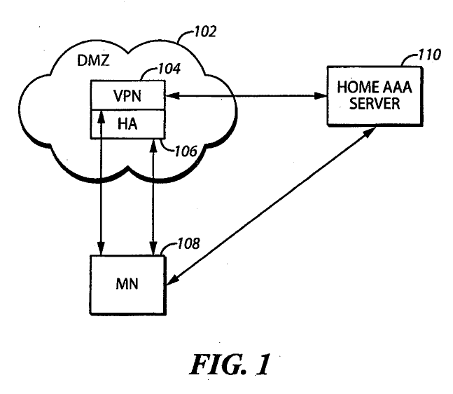

Referring now to FIG. 1, one example of a system for establishing a connection between a VPN server and a mobile node is described. A demilitarized zone (DMZ) network includes a VPN server or gateway 104 and a home agent 106. The VPN server 104 serves as an interface between the mobile node 108 and an AAA server 110. As is known in the art, the home agent 106 provides functionality to communicate with its assigned mobile nodes.

The home agent 106 and the VPN server 104 are components that together form a Mobile VPN (MVPN) server. The MVPN server is a VPN gateway that is able to maintain the IPsec VPN tunnel even for mobile nodes that change their point of connection to the network through MIP. In one approach, the two units 104 and 106 are physically collocated. For example, they may be placed in the same housing. In another example, the two units are physically coupled and held together, but are not situated within the same physical housing unit. In still another approach, the units are only logically connected and are not physically proximate with each other.

The AAA server 110 is communicatively coupled to the mobile node 108 by establishing a link through the VPN server and/or the home agent. The AAA server 110 provides authentication, authorization, and accounting functions for mobile nodes.

The home agent 106 and VPN server 104 are programmed to implement the AAA protocol and provide AAA client functionality. In this regard, the RADIUS or Diameter protocol may be deployed at the VPN server. Other protocols may also be used. In addition, the AAA server 110 and mobile node 108 may share a pre-established AAA key and security association, so that link encryption can be employed. The VPN server 104 and the AAA server 110 share a security association that allows the AAA server 110 to send cryptographic material to the VPN server 104 in an encrypted form.

In one example of the operation of the system of FIG. 1, an AAA key, defining a first shared search between the mobile node 108 and an AAA server 110, is determined, for example, during an initialization period for the system and caused to be provisioned at the mobile node. As described below, a shared key is then formed, at least in part, from the AAA key. The shared key defines a second shared secret, which is shared between the mobile node 108 and the VPN server 104. Using the shared key, a secure data tunnel is then established between the mobile node 108 and the VPN server 104.

In one approach, the shared key is formed and becomes associated with the mobile node 108 and the VPN server 104. Specifically, a nonce representing the shared key may be created at the AAA server 110. The nonce is sent to the mobile node 108 and the shared key is then responsively formed at the mobile node 108 using the nonce. The nonce may be sent to the mobile node 108 via the VPN server 104 and the home agent 106 over an unprotected connection to the mobile node 108.

The shared key may also be formed at the AAA server 110. After being formed, the shared key is sent to the VPN server 104 over a protected connection. This connection is protected through a security association between the VPN server 104 and the AAA server 110. Thus, the shared key becomes associated with both the mobile node 108 and the VPN server 104 and a secure tunnel can then be created between these two entities.

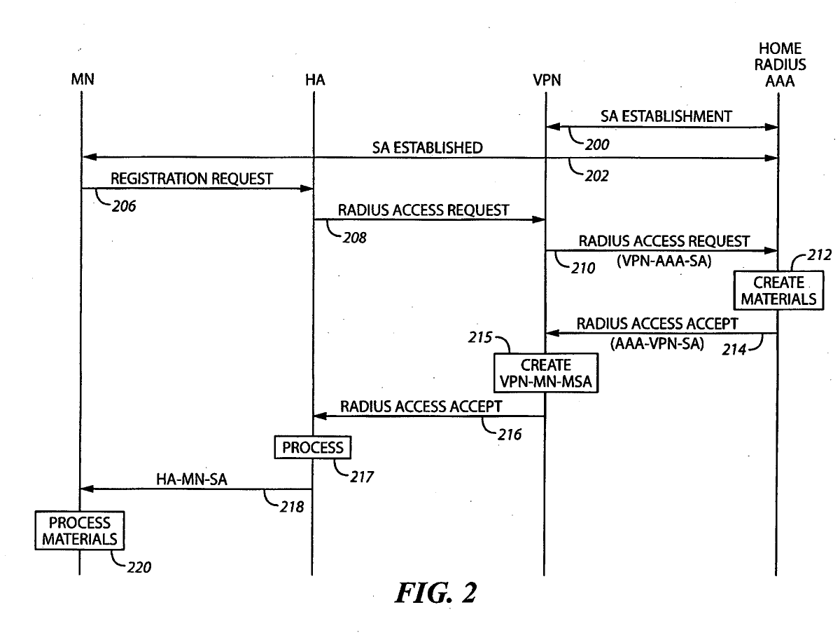

Referring now to FIG. 2, one example of establishing a shared key between a VPN server and a mobile node is described. At step 200, a security association (SA) is established between the VPN server and an AAA server. At step 202, a SA is established between the mobile node and the AAA server.

At step 206, the mobile node sends a registration request to the home agent. The mobile node may add a generalized mobile node-home agent key generation nonce request extension and mobile node-VPN key generation extension to the message. These extensions are discussed in greater detail elsewhere in this specification. The mobile node also creates a mobile node-AAA authentication extension and includes this extension within the registration request. An authenticator field is calculated using an AAA key that was provisioned earlier at the mobile node.

At step 208, the home agent receives the registration request and creates a RADIUS access request message and includes information from the registration request in an attribute in the message. At this point, the home agent does not share any security association with the mobile node and needs to indicate to the AAA server that it requires key material from the AAA server to determine the security association.

Still at step 208, the HA adds the SPI (mobile node-to-home agent SPI) to the RADIUS access request message and forwards the RADIUS access request message with all the above-mentioned attributes to the VPN server. When the VPN server and home agent reside in the same DMZ or housing, no security protection is needed for messaging between the VPN server and the home agent. Otherwise, some form of security protection is preferably used.

At step 210, the VPN server acts as a RADIUS proxy and intercepts the RADIUS access request message from the home agent. The VPN server includes the necessary SPIs in the RADIUS access request message. The VPN server then forwards the modified RADIUS access request message to the AAA server.

At step 212, the AAA server receives the modified RADIUS access request message from the VPN server, extracts the mobile node-AAA authentication extension from a RADIUS attribute that was added to the message, and verifies the authenticator (based on the MN-AAA SA). Once the authenticator is verified, the AAA server proceeds with generating a RADIUS access accept message. The AAA server creates the nonces required by the mobile node-home agent SA and mobile node-VPN SA and inserts these inside a generalized mobile node-home agent key generation nonce reply extension and a generalized mobile node-VPN key generation nonce reply extension.

At step 214, the RADIUS access accept message is sent to the VPN server. As mentioned, various extensions are included inside the mobile node-home agent nonce attribute and mobile node-VPN nonce attributes. The AAA server creates the keys for home agent-mobile node SA and VPN-mobile node SA to match the nonces sent to the mobile node. Since the AAA server sends the keys and not the nonces to the home agent and VPN server, these keys are included in a mobile node-home agent key attribute and mobile node-VPN key attribute, which are encrypted by IPsec. In one example, the entire RADIUS message is encapsulated inside the IPsec channel between the VPN server and the AAA server and sent to the VPN server. At step 215, a VPN-mobile node SA is created where the VPN obtains its own keys from the message and leaves the HA-needed keys for the home agent.

At step 216, the VPN server decrypts the RADIUS accept message, extracts the mobile node-VPN key attribute, and creates a VPN-mobile node SA for authentication with the mobile node. Since this SA is used for an IKE with the mobile node, the algorithm for authentication is either pre-configured or defined by the IKE. The VPN server passes the rest of the message to the home agent in the form of another RADIUS access accept message. The VPN server passes the generalized mobile node-VPN key generation nonce reply extension to the home agent, which in turn forwards it to the mobile node at step 218.

At step 217, the home agent extracts the mobile node-home agent key from the attribute within the RADIUS access accept message and creates a home agent-mobile node SA, which it later uses for authentication of messages (such as registration reply messages) to the mobile node. The home agent also proceeds with creating a MIP registration reply to the mobile node. The home agent finally creates a mobile node-home agent Authentication extension over the entire registration reply (except the IP and UDP headers) to authenticate its reply to the mobile node.

At step 218, the home agent sends the key generation nonce reply extensions for both the mobile node-VPN and mobile node-home agent SAs along with the registration reply back to the mobile node. At step 220, upon receiving the registration reply, the mobile node processes the mobile node-home agent key generation nonce reply extension and extracts the mobile node-home agent nonce. Based upon the nonce and the AAA key, the mobile node calculates the mobile node-home agent SA key and proceeds with authenticating the registration reply received from the home agent by verifying the mobile node-home agent authentication extension submitted by the home agent. If the mobile node-home agent authenticator is correct, the mobile node proceeds with creating a mobile node-VPN SA and mobile node-VPN key, which the mobile node shares with the VPN server and is used to establish a secure data tunnel between the mobile node and the VPN server.

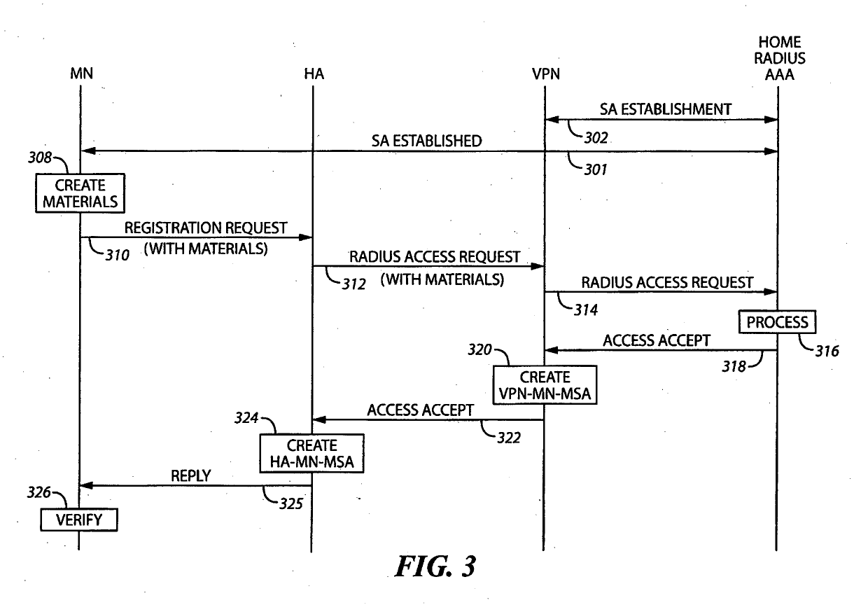

Referring now to FIG. 3, another approach for establishing a shared key between a mobile node and a VPN server is described. At step 302, a security association (SA) is established between the VPN server and an AAA server. At step 304, a SA is established between the mobile node and the AAA server.

At step 308, the mobile node generates the nonces from which keys with the home agent and VPN server can be calculated and adds these nonces inside a generalized mobile node-home agent key generation nonce extension and a mobile node-VPN key generation nonce extension. The format for these two extensions may be the same or similar to the generalized key generation nonce reply extension described above with respect to the registration request message. The mobile node also creates a mobile node-AAA authentication extension and includes this in the registration request. An authenticator field is calculated using the AAA key. At step 310, the mobile node sends the registration request message to the home agent.

At step 312, the home agent creates a RADIUS access request message and includes the registration request as an attribute in the message and sends the message to the VPN server. At this point, the home agent does not share any SA with the mobile node and needs to indicate to the AAA server that it requires key material from the AAA server to form a SA. To facilitate outsourcing of mobile node authentication, the home agent extracts the mobile node-AAA authentication extension into a mobile node-AAA authentication attribute and appends this to the access request message. The home agent may also extract the mobile node-home agent nonce and mobile node-VPN nonce and place these into a mobile node-home agent nonce attribute and a mobile node-VPN nonce attribute, respectively, if desired. The home agent allocates the necessary SPIs and adds them to the RADIUS access request message. The home agent then forwards the RADIUS request message to the VPN server. When the VPN server and home agent reside in the same DMZ or box, no security protection is required for messaging between the VPN server and home agent. Otherwise, some form of security protection is preferably used.

At step 314, when the VPN server is considered as a separate logical entity, the VPN server acts as a RADIUS proxy and intercepts the RADIUS access request from the home agent and sends the request to the AAA server. The VPN server adds the necessary SPIs to the RADIUS access request and forwards this to the home AAA server. The VPN server may protect the RADIUS access request message by providing the authentication mechanism provided by the VPN server-AAA IPsec SA that it shares with the AAA server.

At step 316, the AAA server receives the RADIUS access request message from the VPN server and extracts the mobile node-AAA authentication extension from RADIUS messaging and verifies the authenticator based on the AAA SA that it shares with mobile node. Once the authentication is verified, the AAA server proceeds with generating a RADIUS access accept message. The AAA server creates the mobile node-home agent key and the mobile node-VPN key based on the nonces provided by the mobile node and the AAA key it shares with the mobile node. The AAA server includes the created keys for home agent-mobile node SA and VPN-mobile node SA inside a mobile node-home agent key attribute and a mobile node-VPN key attribute, which may be encrypted by IPsec. In this example, the entire RADIUS message may be encapsulated inside the IPsec channel between the VPN server and the AAA server and sent to VPN server. At step 318, if the VPN server and home agent are not inside the same box, these keys may be sent to VPN server and home agent separately and over independent IPsec channels.

At step 320, the VPN server decrypts the RADIUS accept message, extracts the mobile node-VPN key attribute, and creates a VPN-mobile node SA for authentication to the mobile node. Since this SA is used for IKE with the mobile node, the algorithm for authentication is either pre-configured or defined by the IKE. At step 322, the VPN server passes the rest of the message to the home agent in the form of another RADIUS access accept message.

At step 324, the home agent extracts the mobile node-home agent key from the attribute within the RADIUS access accept message and creates a home agent-mobile node SA, which it later uses for authentication of messages (such as registration reply) to the mobile node. The home agent proceeds with creating a Mobile IP registration reply to the mobile node. The home agent finally creates a mobile node-home agent Authentication extension over the entire registration reply to authenticate its reply to the mobile node and sends it to the mobile node at step 324.

At step 326, upon receiving the registration reply, the mobile node checks the authentication provided by the home agent, since it already has the keys for the mobile node-home agent security association. If the authentication is correct, the mobile node can start using the keys that it had generated for mobile node-home agent and mobile node-VPN interaction.

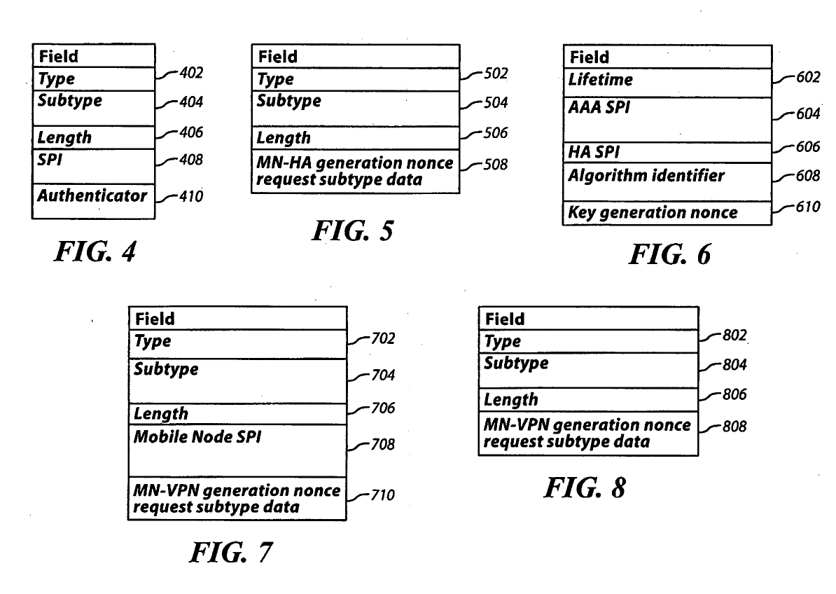

As mentioned previously, various extensions to mobile registration requests are used. These extensions may be taken from Mobile IP standards (e.g., the IETF RFC 3344 and RFC 3012 standards) and modified as described below with respect to FIGS. 4-10. It will be understood that the extensions described below are only examples and other approaches are possible.

Referring now to FIG. 4, one example of a mobile node-to-VPN authentication extension is described. This extension includes a type field 402, a sub-type field 404, a length field 406, an SPI field 408, and an authenticator field 410. The type field 402 indicates the type is VPN authentication extension. The length specifies length of the SPI field. The SPI field 408 represents a security parameter index specifying the SA that the AAA server must use to verify the authenticator field 410 calculated by the mobile node. The authenticator field is data associated with the mobile node and extensions.

Referring now to FIG. 5, an example of a generalized mobile node-to-home agent key generation nonce reply extension is described. The extension includes a type field 502, a sub-type field 504, a length field 506, and a mobile node-home agent generation nonce request data sub-type field 508. The type field 502 indicates the type and the sub-type field 504 indicates a number assigned to identify the way the sub-type data in this extension is used to obtain the registration forms. The length field 506 indicates the length of the extension. The field 508 comprises an encoded copy of the keying material.

Referring now to FIG. 6, one example of a mobile node-to-home agent key generation nonce from AAA data subtype is described. The data sub-type includes a lifetime field 602, an AAA SPI field 604, a home agent SPI field 606, an algorithm identifier field 608, and a key generation nonce field 610. The field 602 is the duration of time in seconds for which the key material can be used to create the key. The field 604 is a number indicating the SPI that the mobile node must use to determine the transform to use for creating the mobile node-home agent SA. The mobile node uses this SPI to locate the AAA key to decrypt the nonce. The field 606 is the SPI for the mobile node-to-home agent SA that the mobile node creates based upon the nonce. The field 608 is an identifier selected from an authentication algorithm table to indicate the exact algorithm to use for computation of mobile node-home agent authentication extension. The field 610 is a 128-bit random number serving the nonce.

Referring now to FIG. 7, one example of a mobile node-to-VPN key generation nonce request extension is described. The extension includes a type field 702, a sub-type field 704, a length field 706, a mobile node SPI field 708, and a mobile node-VPN key generation nonce request data sub-type field 710. The field 702 defines the type of extension. The field 704 is a number assigned to identify the way the data subtype field 710 is used to generate the mobile node-VPN registration key. The field 706 includes the length of the extension. The mobile node SPI field 708 includes the security parameters index that the mobile node assigns for the SA created (VPN-mobile node SA) for use with the registration key (VPN-mobile node key). The VPN server must later include this SPI in the mobile node-VPN authenticating extension for messages from the VPN server to the mobile node. The field 708 is data needed to carry out the creation of the registration key on behalf of the mobile node.

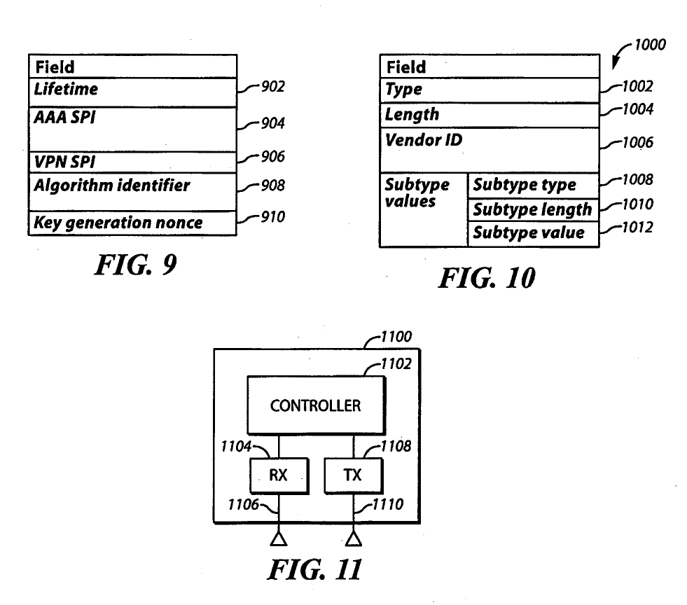

Referring now to FIG. 8, a generalized mobile node-to-VPN key nonce reply extension is described and includes a type field 802, a sub-type field 804, a length field 806, and a mobile node-VPN key generation nonce request data sub-type field 808. The field 802 is the type of message. The field 804 is a number assigned to identify the way the subtype data field 808 is to be used in this extension to obtain the registration key (mobile node-VPN key). The field 806 is the length of the extension. The field 808 is an encoded copy of the keying material and is described with respect to FIG. 9.

Referring now to FIG. 9, the data field 808 of FIG. 8 includes a lifetime field 902, an AAA SPI field 904, a VPN SPI field 906, an algorithm identifier 908, and a key generation nonce field 910. The lifetime field 902 includes the duration of time in seconds for which the key material can be used to create the key. The field 904 is a number indicating the SPI that the mobile node must use to determine the transform to use for creating the MN-VPN SA. The mobile node uses this SPI to locate the AAA key to decrypt the nonce. The field 906 is the SPI that the mobile node uses for the mobile node-to-VPN SA based upon the nonce. The field 908 is an identifier selected from an authentication algorithm table to indicate the exact algorithm to use for computation of mobile node-VPN authenticating. The field 910 is a 128-bit random number serving as nonce.

Referring now to FIG. 10, one example of a RADIUS attribute 1000 is described. The attribute 1000 includes a type field 1002, (for vendor-specific attributes), a length field 1004 (for the length of the attribute), a vendor ID field 1006 (for vendor ID), a sub-type field 1008 for subtype value) a sub-type length field 1008 (for sub type length) and a sub type value field 1010 (for the sub-type value).

The RADIUS attribute sub-type field 1008 may comprise a number of examples. For instance, a Registration ReQuest (RRQ) attribute (type 26/1) may be used. In this case, the registration request in a hashed form is fitted into a RADIUS Vendor Specific Attribute (VSA). If desired, a feature vector may be created to parse the registration request into various attributes in order to offload the AAA server from having to parse the registration request.

In addition, a RRP attribute (type 26/2) sub-type may be used in the sub-type field 1008. The registration reply in a hashed form is fitted into a RADIUS VSA. This attribute type is reserved in case the position of home agent and VPN server relative to AAA server and mobile node are reversed and the registration reply may have to be carried by RADIUS.

In another example, a mobile node-AAA Authorization attribute (type 26/3), which includes the mobile node-AAA authentication extension from the registration request, may be used in the field 1008. This extension is provided as a separate attribute, in case the authenticator value is too long for the attribute length type, and also to let the AAA server easily find the extension.

In still another example, a mobile node-to-home agent SPI attribute (type 26/4) may be used in the field 1008. This attribute is used by the home agent in the RADIUS access request to indicate to the AAA server that the home agent requires keys for the mobile node-to-home agent SA.

In other examples, a mobile node-to-VPN SPI attribute (type 26/5) may be used to indicate to the AAA server that the VPN server requires keys to share with the mobile node. Also, a mobile node-home agent nonce attribute (type 26/6) may be used and includes the generalized mobile node-home agent key generation nonce extension inside a RADIUS access accept message. Further, a mobile node-VPN nonce attribute (type 26/7) can be used that includes the generalized mobile node-VPN key generation nonce extension that is present inside a RADIUS access accept message. In addition, a mobile node-home agent key attribute (type 26/8) can be used that includes the key for home agent-mobile node SA inside the RADIUS access accept message. A mobile node-VPN key attribute (type 26/9) that includes the key for VPN-mobile node SA inside the RADIUS access accept message may also be used. A mobile node-home agent attribute (type 26/10), may also be used if the home agent is to be allocated by the RADIUS server. Other examples of attributes are possible.

Referring now to FIG. 11, one example of an AAA server 1100 is described. The AAA server 1100 comprises a controller 1102, a receiver 1104 (having input 1106), and a transmitter 1108 (having an output 1110). The controller 1102 obtains an associated AAA key and receives a registration request from a mobile node at the input 1106 of the receiver 1104. The controller 1102 is programmed to responsively form a nonce comprising information representative of the AAA key and to form a shared key using the AAA key. The controller 1102 is further programmed to transmit the shared key to a Virtual Private Network (VPN) server and the nonce to the mobile node at the output 1110 of the transmitter 1108. The shared key may use a hiding mechanism, for example, the Remote Authentication Dial-In User Services (RADIUS) attribute hiding mechanism and the Diameter attribute hiding mechanism.

The approaches described herein are simple and cost effective to implement, result in the ability of network entities to conduct secure communications in a network or between networks, and do not create additional burdensome system overhead. Compared with previous approaches, custom programming of keys and/or use of an expensive certificate authority are not required.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of establishing a secure data tunnel between a mobile node and a Virtual Private Network (VPN) server comprising:
acquiring an Authentication, Authorization, and Accounting (AAA) key, the key defining a first shared secret between the mobile node and an AAA server;
causing a shared key to become associated with the mobile node and the VPN server, the shared key being formed, at least in part, from the AAA key, the shared key defining a second shared secret, which second shared secret is shared between the mobile node and the VPN server; and
establishing a secure data tunnel between the mobile node and the VPN server by using the shared key.

2. The method of claim 1 wherein causing a shared key to become associated with the mobile node and the VPN server comprises:
creating a nonce representing the shared key at the AAA server;
forming the shared key at the AAA server;
sending the shared key to the VPN server;
sending the nonce to the mobile node; and
responsively forming the shared key at the mobile node using the nonce.

3. The method of claim 2 further comprising creating keying material for a security association between the mobile node and a home agent at the same time keying material is created for a security association between the mobile node and the VPN server.

4. The method of claim 3 further comprising collocating the home agent and the VPN server within a single unit.

5. The method of claim 3 further comprising positioning the home agent and the VPN server within separate units.

6. The method of claim 2 wherein sending the nonce to the mobile node comprises sending the nonce to the mobile node via a path that includes at least one component selected from a group comprising: the VPN server; a home agent; the VPN server and a home agent.

7. The method of claim 2 wherein sending the nonce to the mobile node comprises sending the nonce over a protected connection.

8. The method of claim 2 wherein causing a shared key to become associated with the mobile node and the VPN server further comprises receiving a registration request at the AAA server, the registration request including a user-defined key generation extension.

9. The method of claim 2 wherein sending the key to the VPN server comprises sending the key over a protected connection.

10. The method of claim 9 wherein receiving a registration request at the AAA server comprises receiving a registration request selected from a group comprising a Remote Authentication Dial-In User Services (RADIUS) request message and a Diameter request message.

11. The method of claim 9 wherein causing a shared key to become associated with the mobile node and the VPN server further comprises authenticating the registration request at the AAA server.

12. The method of claim 1 wherein causing a shared key to become associated with the mobile node and the VPN server comprises:
forming the shared key at the mobile node;
sending a nonce representative of the shared key from the mobile node to the AAA server;
creating the shared key at the AAA server from the nonce; and
sending the shared key from the AAA server to the VPN server.

13. A method of forming a shared key between a mobile node and a Virtual Private Network (VPN) server comprising:
establishing a first key that defines a first shared secret between a mobile node and a first server using a signaling mechanism; and
establishing a set of shared keys and negotiating a set of cryptographic parameters using the first key and the signaling mechanism, the set of shared keys defining a set of second shared secrets that are shared between the mobile node and a Virtual Private Network (VPN) server.

14. The method of claim 13 wherein establishing the first key comprises using an Authentication, Authorization, and Accounting (AAA) key between the mobile node and an AAA server and signaling key generation requests to the AAA server.

15. The method of claim 13 wherein establishing a shared key comprises establishing a shared key for a VPN server and the mobile node using the first key, the shared key defining a second shared secret is shared between the mobile node and the VPN server, the shared key being established at the first server and at the mobile node.

16. An Authentication, Authorization, and Accounting (AAA) server comprising:
a receiver having an input;
a transmitter having an output; and
a controller coupled to the receiver and transmitter, the controller obtaining an associated AAA key and receiving a registration request from a mobile node at the input, the controller programmed to responsively form a nonce comprising information representative of the AAA key and to form a shared key using the AAA key, the controller further programmed to transmit the shared key to a Virtual Private Network (VPN) server and the nonce to the mobile node at the output of the transmitter.

17. The AAA server of claim 16 wherein the registration request includes a user defined MIP extension.

18. The AAA server of claim 16 wherein the shared key uses a hiding mechanism selected from a group comprising a Remote Authentication Dial-In User Services (RADIUS) attribute hiding mechanism and a Diameter attribute hiding mechanism.

19. The AAA server of claim 16 wherein the controller is further programmed to authenticate the registration request and the nonce further comprises a result of the authentication.

20. The AAA server of claim 16 wherein the controller further comprises means for:
creating the nonce representing the shared key;
forming the shared key; and
sending the shared key to the VPN server.
